(19) United States
(12) Patent Application Publication
(10) Pub. No.: US 2011/0055677 A1
(43) Pub. Date: Mar. 3, 2011

(54) SYSTEMS AND METHODS FOR ASSOCIATING AND ORGANIZING DIGITAL FILES

(76) Inventors: Thomas Lima, McKinney, TX (US); Timothy S. Robinson, Flower Mound, TX (US)

(21) Appl. No.: 12/868,198

(22) Filed: Aug. 25, 2010

Related U.S. Application Data
(60) Provisional application No. 61/236,688, filed on Aug. 25, 2009.

(51) Int. Cl. G06F 17/00

(52) U.S. Cl. 715/201

(57) ABSTRACT

Systems and methods for associating digital files into a data project are described. The systems and methods may create a template for a data project. A user may provide inputs for the template. The inputs may define a user-structured data hierarchy, where the user-structured data hierarchy includes a plurality of levels and sub-levels of information. The user may then provide links to one or more digital files associated with each level of the user-structured data hierarchy. The one or more digital files are then associated with corresponding levels of the user-structured data hierarchy. The user-structured data hierarchy and the one or more digital files may be compiled into a data project before being accessed by a user.

### CROSS REFERENCE TO RELATED APPLICATION

This application claims priority to U.S. Provisional Patent Application No. 61/236,688, filed Aug. 25, 2010; the content of which is incorporated herein by reference in its entirety.

### FIELD OF THE INVENTION

The present invention relates to digital file management and, more specifically, to systems and methods for associating digital files into organized bundles for presentation to an end user.

### BACKGROUND OF THE INVENTION

Needs exist in various industries for collecting and processing data files from various sources into a cohesive, organized bundle that can be easily viewed and used by an end user. Digital file management programs typically aggregate and organize single file types. Many industries, however, require collection of various types of data, and organization of that data into specific presentation formats. One particular example is the insurance industry. In legal cases where damages are being sought from another party, the process is initiated with a demand letter and/or associated demand package prior to filing suit. The demand package is a standardized collection of information useful in presenting a case for damages. Most demand packages include the following documentation:

1. Written demand letter;

2. Accident report;

3. Medical records

4. Medical bills; and

5. Photographs.

Traditionally, demand packages are hard copies of the relevant documentation. Standard demand packages may contain as few as 25 to 50 pages up to and exceeding several hundred pages. Hard copies of the demand package are sent to the insurance company and the client. A copy of the demand package is also retained by the preparing law firm. The demand packages are prepared by legal support staff that organize and gather information, assemble the package, then print and file the necessary copies. The estimated cost of production and mailing of a single demand package is between about $150 and $200 per package.

Lawyers that do not focus on personal injury cases may prepare 20 to 30 demand packages per year, while those that focus on these type cases may prepare as many as 400 to 500 or more demand packages a month. The number of demand packages created in the United States is estimated to exceed 13,000,000 per year or over one million per month. Assuming that the average cost of production and mailing is $150/package; nearly two billion dollars is spent annually on demand packages. Assuming the average size per demand package is 50 pages and two copies are made, this would require 1,950,000,000 pieces of paper.

With rare exception, the more than 13,000,000 demand packages prepared annually are all in writing. Despite the inroads of technology and access to the latest software and computer technology, demand packages today are prepared the same way they have been prepared for centuries.

There are many software packages that allow the linear presentation of information and/or data within the confines of their particular program (i.e., Power Point, etc); however, there are no existing programs that allow the incorporation and manipulation of various file types with non-linear functionality. Needs exist for improved systems and methods for associating digital files into organized bundles that provide non-linear functionality.

### SUMMARY OF THE INVENTION

Embodiments of the present invention solve many of the problems and/or overcome many of the drawbacks and disadvantages of the prior art by providing systems and methods for associating digital files into organized bundles.

Embodiments of the present invention may include systems and methods for associating digital files into a data project. Systems and methods for associating digital files into a data project are described. The systems and methods may create a template for a data project. A user may provide inputs for the template. The inputs may define a user-structured data hierarchy, where the user-structured data hierarchy includes a plurality of levels and sub-levels of information. The user may then provide links to one or more digital files associated with each level of the user-structured data hierarchy. The one or more digital files are then associated with corresponding levels of the user-structured data hierarchy. The user-structured data hierarchy and the one or more digital files may be compiled into a data project before being accessed by a user.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows an exemplary system for associating digital files into organized bundles in a networked computing environment.

FIG. 2 shows an exemplary server for associating digital files into organized bundles in a networked computing environment.

FIG. 3 shows a graphical user interface according to one exemplary embodiment.

FIG. 4 shows a process for associating digital files into organized bundles.

FIG. 5 shows a process for associating digital files into organized bundles.

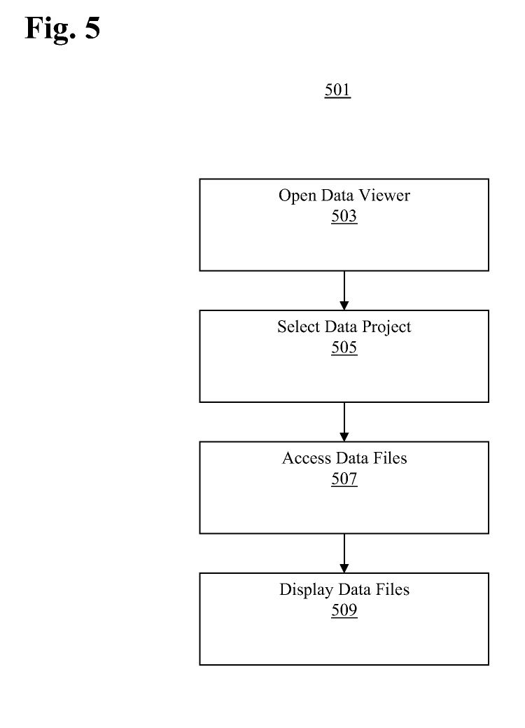

### DETAILED DESCRIPTION OF THE PREFERRED EMBODIMENTS

Systems and methods are described for associating digital files into organized bundles in a variety of industries. The examples described herein relate to the preparation of demand packages for the insurance industry for illustrative purposes only. The systems and methods described herein may be used for many different industries, including, for example, advertising, business proposals, and many others. The systems and methods may be used by anyone who needs a non-linear (fully inter-active) presentation device, such as professors, speakers, business managers, attorneys (all disciplines), and everyone else who needs want to provide data to another. For example, defense attorneys can use the product to send all records and reports to clients on cases in litigation; attorneys can use the product to send records to experts retained in litigation; attorneys, or businessmen, can use the product to very quickly, with any technical knowledge of software programming, create a project sending the recipient many different forms of data (i.e., video, PDF, etc.).

Although not required, the systems and methods are described in the general context of computer program instructions executed by one or more computing devices. Computing devices typically include one or more processors coupled to data storage for computer program modules and data. Key technologies include, but are not limited to, the multi-industry standards of Microsoft Operating Systems, SQL Server, .NET Framework (VB.NET, ASP.NET, AJAX.NET, etc.), Oracle database BIEE products, other e-Commerce products and computer languages. Such program modules generally include computer program instructions such as routines, programs, objects, components, etc., for execution by the at least one processor to perform particular tasks, utilize data, data structures, and/or implement particular abstract data types. While the systems, methods, and apparatus are described in the foregoing context, acts and operations described hereinafter may also be implemented in hardware.

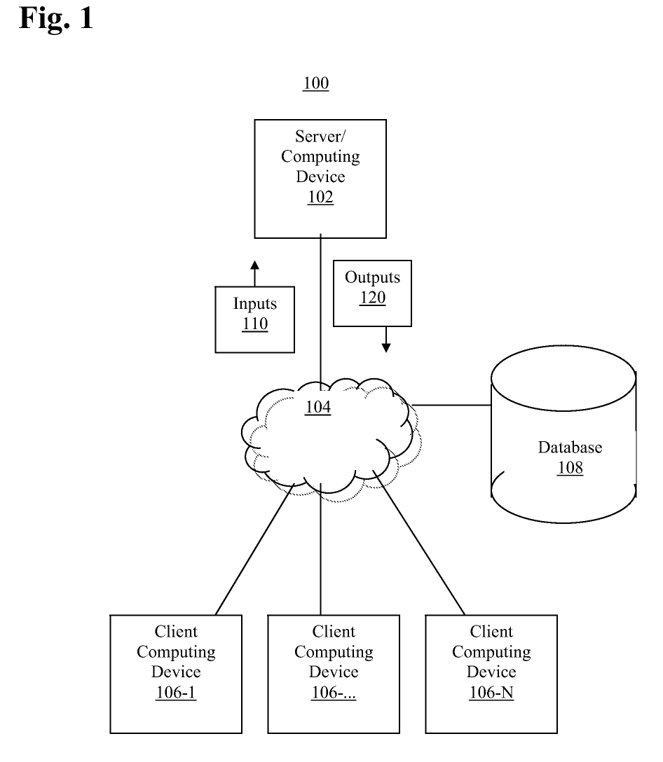

FIG. 1 shows an exemplary system 100 for associating digital files, according to one embodiment. In this exemplary implementation, system 100 includes digital file association server/computing device 102 operatively coupled over network 104 to one or more client computing devices 106 (e.g., 106-1 through 106-N) and one or more databases 108. Digital file association server/computing device 102 represents, for example, any one or more of a server, a general-purpose computing device such as a server, a personal computer (PC), a laptop, and/or so on. Networks 104 represent, for example, any combination of the Internet, local area network(s) such as an intranet, wide area network(s), and/or so on. Such networking environments are commonplace in offices, enterprise-wide computer networks, etc. Client computing devices 106, which may include at least one processor, represent a set of arbitrary computing devices executing application(s) that respectively send data inputs 110 to digital file association server/computing device 102 and/or receive data outputs 120 from digital file association server/computing device 102. Such computing devices include, for example, one or more of desktop computers, laptops, mobile computing devices (e.g., PDAs), server computers, and/or so on. In this implementation, the input data comprises, for example, data hierarchy, data files, due dates, and/or so on, for digital file association with system 100. In one implementation, the data outputs include, for example, a current valuation, future valuation, and/or so on. Embodiments of the present invention may also be used for collaborative projects with multiple users logging in and performing various operations on a data project from various locations. Embodiments of the present invention may be web-based.

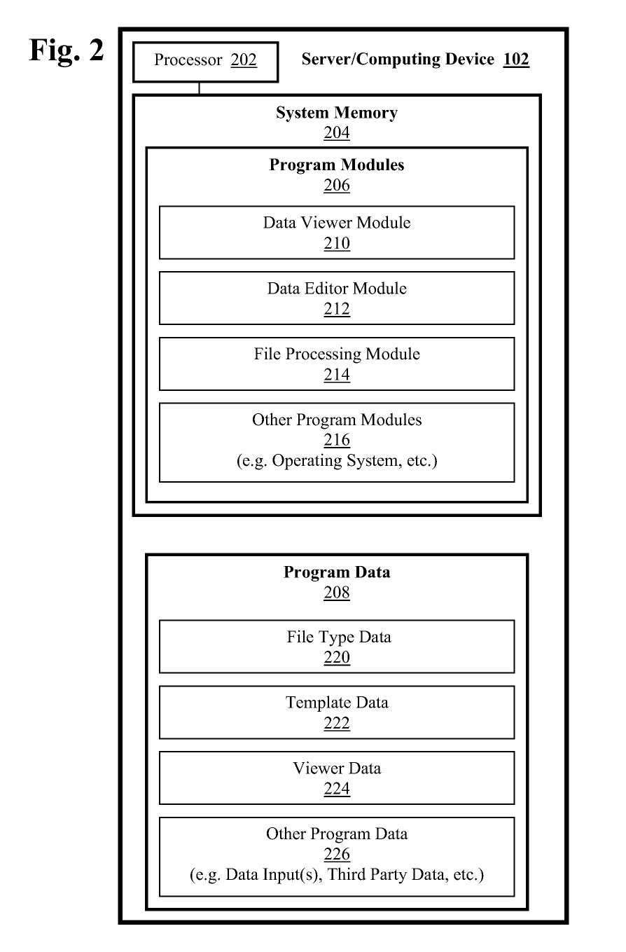

In this exemplary implementation, server 102 includes at least one processor 202 coupled to a system memory 204, as shown in FIG. 2. System memory 204 includes computer program modules 206 and program data 208. In this implementation program modules 206 include data viewer module 210, data editor module 212, file processing module 214, and other program modules 216 such as an operating system, device drivers, etc. Each program module 210 through 216 includes a respective set of computer-program instructions executable by processor(s) 202. This is one example of a set of program modules and other numbers and arrangements of program modules are contemplated as a function of the particular arbitrary design and/or architecture of server 102 and/or system 100 (FIG. 1). Additionally, although shown on a single computing device 102, the operations associated with respective computer-program instructions in the program modules 206 could be distributed across multiple computing devices. Program data 208 may include file type data 220, template data 222, viewer data 224, and other program data 226 such as data input(s), third party data, and/or so on.

Embodiments of the present invention may include a completely digital file association package for compiling and presenting information. In a preferred embodiment, the information may be related to demands in insurance situations, and result in the creation of a completely digital demand package.

Embodiments of the present invention may include a data editor and a data viewer. The data editor and the data viewer may be used separately and/or in combination.

A data editor may allow a creating user to create a bundle of associated data files. The bundle of associated data files may be arranged according to the preferences of the creating user in a data project. The data project may maximize effectiveness of the presentation of the materials. In the situation of a demand package, the creating user may be an attorney or member of the attorney's staff. The data files within the demand package may be organized such that they are presented in a logical, persuasive manner. By utilizing the data editor, the creating user may quickly assemble a demand package that contains all of the traditional items included in a demand package, including a written demand letter, accident report, medical records, medical bills, and photographs. Additionally, the demand package may incorporate: (1) digital images; (2) image sequences; (3) videos; (4) PDF documents; (5) text documents; (6) presentation files; and many other electronic file formats. Data may be encrypted onto a storage device such that after a data project is finalized it cannot be edited except by a user with editing access.

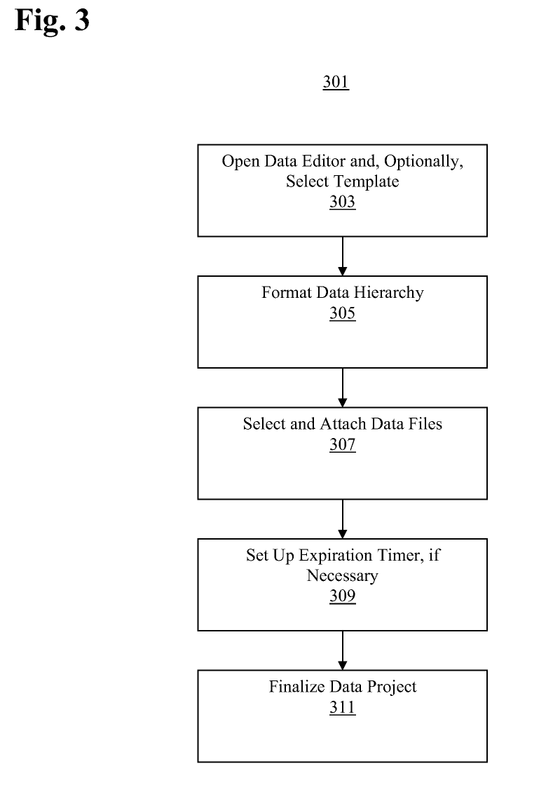

FIG. 3 illustrates the preparation of a data project 301. To prepare a data project in the data editor, the creating user may perform several steps. Initially, the creating user may open the data editor and, optionally, open a template 303. Templates may be opened/created by the data editor. The template may be a blank template, a predetermined template, and/or a customized template. The template may include predetermined locations to place various information. Template structures may be developed by the end user. For example, if a law firm wants: (1) a video introduction; (2) clients statement; (3) accident reports; (4) photographs; (5) medical records; (6) medical bills; and (7) a written demand in every package, the law firm may create this particular array of options in the data hierarchy each time a new data project is created. The law firm may save this particular data hierarchy as a template structure that can be loaded before beginning each data project. By entries in the data hierarchy, speed of completion of the data package is increased. Additionally, if sub-headings are added (i.e., for medical records and bills from multiple institutions), the sub-headings may automatically be filled/auto-named as sub-titles when a digital file is selected. By using a template structure and the auto-name feature, the data project can be assembled with minimal or without any manual entry of information. One predetermined location may be a place to attach and organize data files. Data files may be attached and organized in a data hierarchy 305.

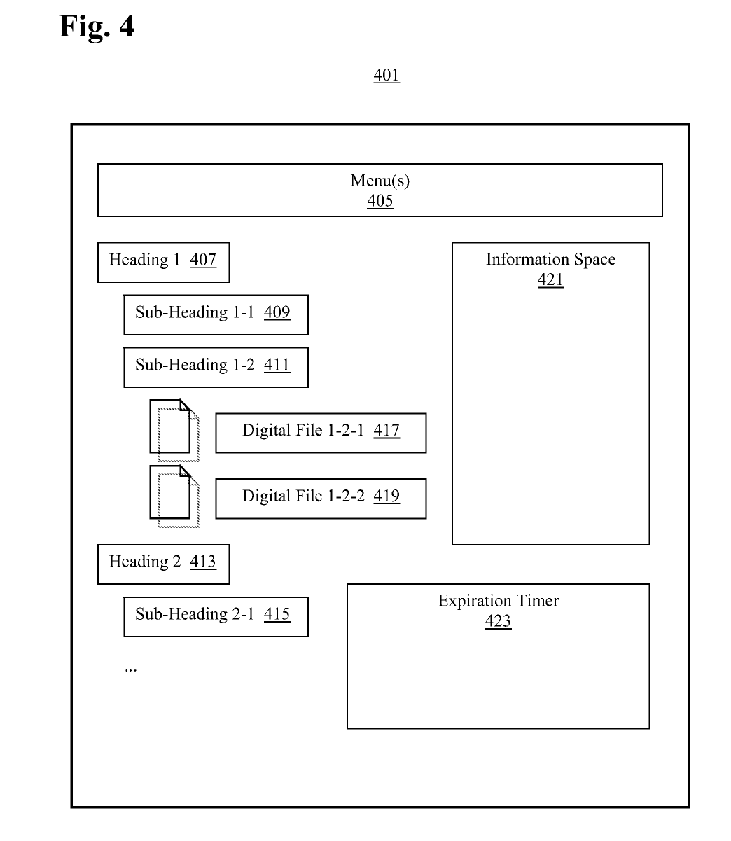

FIG. 4 illustrates an exemplary graphical user interface 401 with a data hierarchy. The graphical user interface 401 may include one or more menus 403. In this example, headings or titles may be added to the data hierarchy. The headings or titles may describe the data files being attached. The data hierarchy may be in the form of a tree structure. A first heading 405 may have two sub-headings 407, 409. A second heading 411 may have one sub-heading 413. The number and arrangement of headings and subheadings may be altered depending on the particular situation. In the context of a demand package, titles may include “Demand Letter”, “Medical Bills”, “Accident Scene Video”, etc. Sub-headings or sub-titles may be included under each main heading or title. To add a heading or sub-heading, the creating user may select “add heading” or another similar command from a menu, press one or more relevant on-screen button within the graphical user interface, type a text command, etc. The creating user may then add the appropriate name to the heading or sub-heading by typing, selecting options and/or responding to prompts from the data editor.

After a heading or sub-heading is created, one or more data files may be associated with each heading or sub-heading 307. Data files may be added by selecting the heading or sub-heading and accessing a menu, pressing an on-screen button, typing a text command, responding to prompts, auto-fill, or other similar methods. The creating user may select the source of data and select the desired one or more data files. The creating user may repeat any of the steps in the creation of the data hierarchy and/or associating files until the data project is complete. Referring to FIG. 4, data files 417, 419 may be associated and displayed with related headings and sub-headings.

During the creation of the data project, the creating user may identify or be prompted to identify the recipient of the data package, a company of the recipient, an address of the recipient, and other administrative details. Other information that may be required may depend on the nature of the data project. For a demand package, information may include the name of a particular case, the amount of special damages, the ultimate demand and other information. The data editor may automatically compile this information and create a demand summary. The demand summary may be displayed, saved and/or incorporated into the data project. The demand summary may be accessible through menus, on-screen selections, text commands, etc.

The creating user may choose the order that materials in the data project are displayed to a receiving user. The displayed order may differ from the order the digital files are arranged in the data hierarchy. For example, a demand letter may be the first attached document in the data hierarchy, but the creating user may want the receiving user to initially see an introductory video. The creating user may designate the preferred order of display. The first displayed data file may be selected through menus, on-screen selections, text commands, auto-fill, etc. The creating user may determine if the first displayed data file is displayed first each time the data project is accessed or only the first time. In addition to structured display of the digital files, embodiments of the present invention preferably allow for non-linear display and review of the digital files. A receiving user of the data project may review the digital files in any order, including repeated viewing without replaying the original sequence of digital files. In a preferred embodiment, when the receiving user opens the data package the information may be displayed according to the order suggested by the creating user. Afterwards, however, the receiving user may browse the data files in any order.

A tool palette may be included in the data editor. The tool palette may be launched via a menu selection, on-screen selection, text command, etc. The tool palette may be displayed on the graphical user interface. The tool palette may contain up and down arrows and/or selection buttons. The up and down arrows may allow the creating user to move a selected heading, sub-heading or data file up or down within the data hierarchy. Options on the tool palette may include the ability to: (1) change a heading to a sub-heading and back; (2) load/attach a digital file to the heading or sub-heading; (3) clear/delete a digital file from the heading or sub-heading; (4) add or remove a heading or sub-heading; and (6) attach a sequence of images. Other options are possible. When attaching a series of images, the series of images may be viewed in a flash viewer. The tool palette may allow the creating user to create a data project and attach relevant data files according to the desired structure and content of the data project. When a digital file is entered in the data hierarchy, the data editor may display a preview in a preview screen. Similarly, whenever a data file is selected in the data hierarchy, a preview may be shown.

At any point during creation of the data project, the creating user may determine whether the data project requires a due date 309. A due date may be the date and/or time that a response to the data project is required for time sensitive materials. In the case of advertising or business deals, the due date may be the time when the promotion or offer is no longer valid. In the case of demand packages, the due date would be the expiration date of the demand. To implement an expiration timer 423, the creating user may select this option and enter the date and/or time of the due date. This information may be entered into the data editor based upon prompts, menu options, text commands, etc. The expiration timer 423 may be displayed on the graphical user interface 401 of the data editor and/or the data viewer. For example, in the data editor, the expiration timer may be displayed in a certain location within the graphical user interface 401. In certain embodiments, when the data project has expired, a large water-mark may say “DATA PROJECT EXPIRED” or other similar language across a face of the data viewer. The expiration timer may calculate the days, hours, minutes, and second that have passed since the data project expired. In certain embodiments, if no due date is set in the data editor, no expiration timer appears on the viewer.

Embodiments of the present invention may include a transfer data function. The data transfer function may allow the creating user to transfer the data project to the receiving user. The data project may be transferred electronically to the receiving user via the Internet using a built in file transfer protocol and/or an external email program. Alternatively, the data project may be transferred to a recordable media that is sent to the receiving user. Recordable media may include CDs, DVDs, flash drives, etc. In a preferred embodiment, the creating user may insert a CD or DVD into a CD/DVD drive and the data project is burned to the CD or DVD.

Optional embodiments of the present invention may include secured access. A creating user and/or a receiving user may be required to login to the data project before editing and/or viewing, respectively. Additionally, an initial information screen may be displayed prior to accessing the data editor and/or data viewer. The initial information screen may include information about the particular data project, including identification information.

Embodiments of the present invention may also include a data viewer 501. The data viewer may be used by the creating user to preview the data project and/or by the receiving user to view the data project. At any point in the creative process or after completion, the data viewer may be used to see the current state of the data project. To operate the data viewer, the creating user preferably saves the data project and opens the data viewer 503. The user may then select a data project for viewing 505. The preview may be launched by pressing a “Launch Viewer” or similar button, selecting an option from a menu, pressing a certain set of keys, etc. The system may then access the relevant data files 507 and display the data package 509. The data viewer may be displayed within an information space 421 of the data editor and/or may launch a separate window. If the attachment is a video, the creating user may play the video in the data viewer to make sure that the correct file is being attached. The data viewer may be fully self-contained and self-executing. Other than when outside programs (i.e., Power-point, Word, etc) are called upon, the user needs nothing other than a computing device to view the data viewer. Plug-ins may be provided for certain programs, such as Windows Media Player, Adobe Acrobat Viewer, Quicktime, etc. Other digital files may be read by calling on outside programs.

When the data viewer is run by the receiving user, the expiration timer may be displayed. The expiration timer may be formatted to display one or more of days, hours, minutes, and seconds. The expiration timer may be displayed in a set location of the data viewer. The expiration timer may display and count down the time remaining before the information within the data project expires. The message displayed may be altered by the creating user depending on particular requirements. In certain embodiments, when the Countdown timer reaches “0”, a watermark stating “EXPIRED” or similar language may be displayed across the data viewer. The data viewer can still be run even with the water mark. The data editor may allow the creating user to label the expiration timer whatever title is desired, i.e., “Stowers Demand”, “Demand Expires”, etc.

Embodiments of the present invention may include a multiple image viewer for viewing two or more images simultaneously. The viewer may include features such as zoom, pan, crop, etc. Embodiments may also include an audio system to play audio files and/or video files that include audio information. In preferred embodiments, audio formats may be converted to play in a FLASH or other type of player. In certain embodiments, there may be a slideshow option for the “First Play” section.

Embodiments of the present invention may have a “Demand Summary” function that makes the compiled files and structure into an actual demand. The “Demand Summary” may create an actual graphic. With this feature, the user can (within the program), set forth (1) a summary of the liability facts; (2) summary of the injuries suffered by the claimants; (3) summary of aggravating factors; (4) summary of special damages; and (5) actually make the demand. Therefore, a summarization image may be completed based on the compiled files and information. In an illustrative example, the “Demand Summary” graphic may display case information, special damages and a total requested amount of damages. The generation of the “Demand Summary” may be automatic, or the information displayed may be selected by a user.

Certain embodiments of the present invention may also have a background file converter. The background file converter may convert all files of a certain type to a native file format. For example, all video file types may be converted to FLV.

The systems and methods described herein may associate and process many different digital file types. Digital file types may include, but are not limited to, *.aac, *.avi, *.bmp, *.doc, *.docx, *.dwg, *.exe, *.f4v, *.flv, *.gif, H.264 encoded mp4 and mov file types, *.html, *.html, *.imgsew, *.jpg, *. jpeg, *.mov, *.mp3, *.mp4, *.mpg, *.obj, *.ogg, *.pcx, *.pdf, *.png, *.png24, *.png32, *.png8, *.pps, *.ppsx, *.ppt, *.rtf, *.swf, *.tif, *.tiff, *.tga, *.txt, *.wav, *.wmv, *.xl, *.xls, *.xlsx, *.xml, etc.

Certain embodiments of the present invention may include a method for creation of a digital demand package. In the method, electronic documents related to a demand for damages in an insurance situation may be received. User inputs regarding organization and structuring of the electronic documents in a digital demand package may also be received. The electronic documents may be organized and structured into a data hierarchy before being compiled with the organization and structure information into a digital demand package. The digital demand package may be output for display, storage, etc.

Embodiments of the present invention may be used to reduce cost of transferring information in various digital file formats. In the case of demand packages, attorneys may substantially reduce cost by: reducing actual assembly time of demand packages; eliminate paper from the demand package; eliminate supplies such as divider tabs; eliminate labor and storage space required for copying and filing the demand packages on paper; and drastically reduce the shipping costs required to forward the demand packages to the insurance company and client. The net effect may be to reduce the average cost of each data project from about $150.00 per package to less than half the current cost. In addition to the cost benefits, the attorneys may take advantage of adding electronic media, which may be more effective in adding value to the case. Similarly, the insurance companies may use embodiments of the present invention to move towards a paperless environment.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A method for associating digital files into a data project, the method comprising:
creating a template;
receiving inputs for the template from a user, wherein the inputs define a user-structured data hierarchy, and wherein the user-structured data hierarchy comprises a plurality of levels and sub-levels of information;
receiving links to one or more digital files associated with each level of the user-structured data hierarchy;
associating each level of the user-structured data hierarchy with the corresponding one or more digital files;
compiling the data hierarchy and the one or more digital files into a data project; and
providing access to the data project.

2. The method of claim 1, further comprising displaying the data project.

3. The method of claim 2, wherein the data project may be manipulated non-linearly after providing access to the data project.

4. The method of claim 1, wherein the data project is a demand for damages in an insurance situation.

5. The method of claim 1, further comprising creating an expiration timer for the data project, wherein the expiration timer counts down to the expiration of the information in the data project.

6. The method of claim 1, wherein the digital files are selected from the group consisting of images, videos, text, spreadsheets, presentation documents, web pages, and combinations thereof.

7. The method of claim 1, further comprising receiving selections for a displayed order of the one or more digital files in the data project.

8. The method of claim 1, further comprising providing a preview of the data project.

9. The method of claim 1, further comprising transferring the data project to a recordable media.

10. The method of claim 1, further comprising receiving edits to the data hierarchy from a user.

11. The method of claim 1, further comprising receiving identifying information about the data project and embedding the identifying information within the data project.

12. The method of claim 1, further comprising receiving a selection of a template from a user prior to creating the template.

13. A method for viewing a data package, the method comprising:
receiving a data project, wherein the data project comprises one or more digital files of one or more data types structured by a creator-structured data hierarchy;
determining the creator-structured data hierarchy structure embedded within the data project;
accessing the one or more digital files according to information embedded within the creator-structured data hierarchy;
displaying the one or more digital files to a user; and
allowing non-linear accessing of the various data files.

14. The method of claim 13, further comprising initially displaying the one or more digital files in a linear format.

15. The method of claim 13, further comprising displaying multiple images at once.

16. The method of claim 13, further comprising displaying an expiration timer for the data project.

17. The method of claim 13, wherein the data project is a demand for damages in an insurance situation.

18. A method for creation of a digital demand package, the method comprising:
receiving electronic documents related to a demand for damages in an insurance situation;
receiving user inputs regarding organization and structuring of the electronic documents in a digital demand package;
organizing and structuring the electronic documents in a data hierarchy;
compiling the electronic documents and organization and structure information into a digital demand package; and
outputting the digital demand package.

19. The method of claim 18, wherein the digital demand package is viewable non-linearly.

20. The method of claim 18, wherein the digital demand package further comprises an expiration timer for the digital demand package, wherein the expiration timer counts down to the expiration of information in the digital demand package.
